(19) United States
(12) Patent Application Publication
(10) Pub. No.: US 2021/0284389 A1
(43) Pub. Date: Sep. 16, 2021

(54) Container with an Inner Decorative Figure and Method for Manufacturing Same

(71) Applicant: Vitro, S.A.B. de C.V., Monterrey (MX)

(72) Inventors: Humberto González Popoca, Metepec (MX); Miguel Ángel Proa Pérez, Toluca (MX); Braulio Rosas Fernández, Ciudad de Mexico (MX); Gustavo Bobadilla Cortés, Tenango del Valle (MX); Guillermo Perales Aldaco, Toluca (MX); Juan Picazo Ortega, Ciudad de Mexico (MX); Miguel Ángel Ortiz Caravantes, Toluca (MX)

(21) Appl. No.: 17/262,481

(22) PCT Filed: Apr. 10, 2019
(86) PCT No.: PCT/MX2019/000033

§ 371 Date: Jan. 22, 2021

(30) Foreign Application Priority Data
Jul. 25, 2018 (MX) MX/A/2018/009111

(51) Int. Cl. B65D 23/14; A45D 34/02

(52) U.S. Cl. CPC B65D 23/14; A45D 2034/007; A45D 34/02

(57) ABSTRACT

The present invention relates to a container with an inner decorative figure and its manufacturing method. The container has a container body having a top cover. The top cover has an outlet neck projecting from the central portion to engage a cap; and, a geometric or amorphous through-peripheral wall in the lower part of the container body. The through-peripheral wall has an external peripheral wall and an internal peripheral wall. The external peripheral wall has a threaded section. A figure includes an upper section with the desired figure and a lower section. The lower section has a stop section to delimit the entrance of the figure towards the inside of the container; and, a lower cap that is coupled to the lower part of the container body to retain and maintain fixed the position of the lower section of the decorative figure.

### CROSS-REFERENCE TO RELATED APPLICATIONS

This application is the United States national phase of International Application No. PCT/MX2019/000033 filed Apr. 10, 2019, and claims priority to Mexican Patent Application No. MX/a/2018/009111 filed Jul. 25, 2018, the disclosures of which are hereby incorporated by reference in their entirety.

### FIELD OF THE INVENTION

The present invention relates to the production of glass containers and more specifically to a container with an inner decorative figure and its manufacturing method.

### BACKGROUND OF THE INVENTION

Glass articles such as glass bottles are typically produced on glass article forming machines of the type that can include multiple similar individual forming sections, by the blow-blow process, while wide-mouth jars, glasses and other glass articles are produced in the forming machines known as series “E” and “F” by means of the press-blow process, in the so-called “hot mold”.

In the process of manufacturing the containers by means of the blow-blow or blow press process, the glass in the form of gobs is introduced into a parison or pre-formed mold in the parison forming station, where, depending on the process, the gob settles through a blowing or vacuum process, to the bottom of the parison mold, to form the crown of the container. Then, once the crown of the container is formed, a counterblow is made to form a parison or preform of the container. Subsequently, the preform of the container is transferred by means of an inversion mechanism, with a 180 degrees movement of said parison mold, to a final blow mold of the deformed station or final blow, where the final shape is given to the container. Finally, the newly formed container is transferred by a pushing mechanism to a dead plate in the front of the machine and, later, it is carried by means of a conveyor belt to a tempering oven where it is decorated or packed.

Most of the containers for the beer, soft drink, perfumery and food industries are made using these processes.

However, in the case of containers for the perfumery industry, they require more design, since in addition to fragrance, they seek to highlight their product with a prominent form of packaging. That is, the packaging is presented to the consumer is one more element of market strategy and a key issue to connect the consumer. The container or bottle quickly tells us what perfume is in front of us, who is behind it and what values can be directly associated with them.

Therefore, the present invention refers to a new type of container that is composed of two or more pieces, which is assembled with a figure or decorative piece in its internal part.

The container with an inner decorative figure consisting mainly of:

A container body having a top cover, said top cover including an outlet neck projecting from the central portion to engage a cap or an atomizer; and, a geometric or amorphous shape through peripheral wall in the lower part of the container body, said geometric or amorphous shaped through peripheral-wall having an external peripheral wall and an inner peripheral wall, said external peripheral wall having a threaded section or whatever type of section for coupling by some method of closure;

a figure or decorative piece including an upper section with the desired figure and a lower section or support base, said lower section or support base having a retainer section to delimit the entrance of the figure or decorative piece towards the inside of the container; and,

a bottom cap or base that engages the lower part of the container body to retain and hold the position of the lower section or support base of the decorative figure.

### OBJECTIVES OF THE INVENTION

It is therefore a first objective of the present invention, to provide a container with an inner decorative figure that allows to manufacture more attractive containers for the perfume industry.

It is another objective of the present invention, to provide a container with an inner decorative figure that allows the formation of containers of irregular shapes.

These and other objects and advantages of the present invention will be apparent to those skilled in the art from the following detailed description thereof.

### BRIEF DESCRIPTION OF THE DRAWINGS

FIG. 1 is a conventional perspective view of a container with an inner decorative figure in accordance with the present invention;

FIG. 2 is an exploded side view of the container with an inner decorative figure in accordance with the present invention; and,

FIG. 3 is an assembled side view of the container with an inner decorative figure in accordance with the present invention.

### DETAILED DESCRIPTION OF THE INVENTION

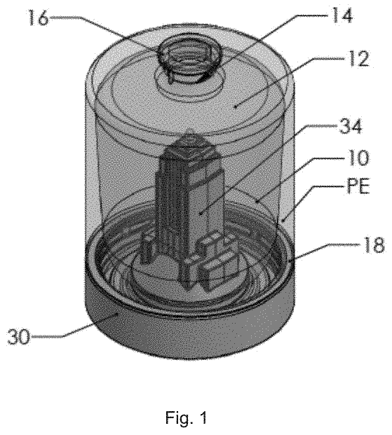

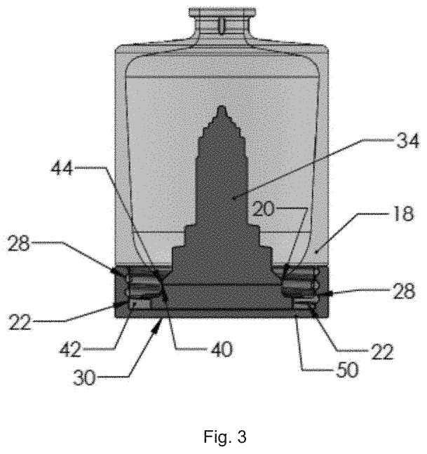

Each of the parts of the container of the present invention will be described in detail below, according to FIGS. 1 to 3, which comprises: a first cylindrical body (10) that can have the shape of a prism, pyramid or cone truncated, cylindrical or of any amorphous shape, which has an upper cover (12). On the upper cover (12) it includes an outlet neck (14) that projects from the central part. Said outlet neck (14) has formed on its external circumference a threaded section or upper peripheral rim (16), for coupling a cap or an atomizer (not shown). The lower part (18) of the cylindrical body (10) includes a peripheral wall (20), which projects horizontally towards the inside of the container. In the lower part of the peripheral wall (20) a through-ring or peripheral wall (22) of geometric or amorphous shape is integrally formed, with a diameter or area slightly smaller than the first cylindrical body (10). The ring (22) having an external peripheral wall (26) which may include a threaded section or with a peripheral flange (28), for the base cover assembly (30), as will be described later; and, an internal through-peripheral wall (32) for the introduction of a decorative FIG. 34) to the internal part of the container.

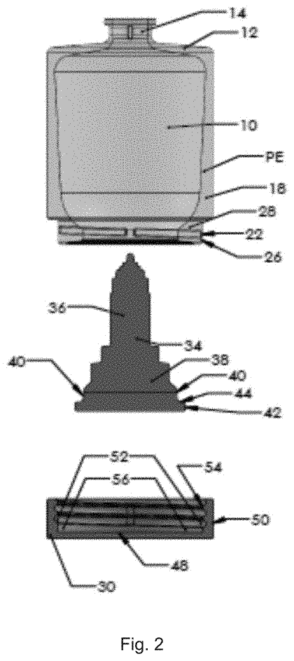

As shown in FIG. 2, the decorative piece (34), which can be of any shape, includes an upper section (36) with the desired figure (the figure of a building is shown in the example shown) and a lower section or support base (38). The lower section or support base (38) having a first external peripheral wall (40) that engages, during the assembly of the decorative figure, coinciding with the internal part of the internal wall (32) of the through-ring or peripheral wall (22); and, a second peripheral or base wall (42) located at the bottom of said first peripheral wall (40). Said second peripheral or base wall (42) being of a diameter greater than said first external peripheral wall (40). The union of the first external peripheral wall (40) and the second peripheral wall or base plate (42) forming a stepped section (44), which serves as a stop when the decorative FIG. 34) is introduced towards the internal part of the container.

And, finally, the lower cover or base (30), which can also be cylindrical, triangular, square or of any amorphous shape, which includes a lower plate (48), an external peripheral wall (50), which it is projected vertically upwards and in linear coincidence, in the same plane, with the external wall (PE) of the first cylindrical body (10); and a first inner peripheral wall (52) having a threaded or closing coupling section (54) which, during assembly, is coupled with the threaded section or the section having the closing or coupling system (28) of the external peripheral wall (26) of the through-ring or peripheral wall (22); and, a second peripheral retaining wall (56), located on the inside of the lower cover or base (30) to retain and keep fixed the position of the lower section or support base (38) of the decorative FIG. 34).

As can be seen from the above, a method to manufacture a container with an inner decorative figure comprising the stages of:

forming a container body (10) with top cover (12), said top cover (12) including an outlet neck (14) projecting from the central part to engage a cap or an atomizer; and, a through-ring or peripheral wall (22) in the lower part of the container body (10), said ring (22) having an external peripheral wall (26) and an inner peripheral wall (32), said external peripheral wall (26) having a threaded section or a peripheral rim (28);

forming a figure or decorative piece (34) including an upper section with the desired decorative FIG. 36) and a lower section or support base (38), said lower section or support base having a stepped section or stop (44);

introducing the figure or decorative piece (34) into the internal part of the container body (10) through the central part of the through-ring or peripheral wall (22) until the stop section (44) of the lower section or base support coincides with a lower part of the ring or peripheral wall (22), to delimit the entrance of the figure or decorative piece (34) towards the internal part of the container; and,

coupling a lower cover or base (30) to the external peripheral wall of the through-ring or peripheral wall (22) of the lower part (18) of the container body (10), to retain and maintain fixed the position of the lower section or support base (38) of the decorative FIG. 34).

The method of manufacturing a container with an inner decorative figure including the step of: hermetically sealing the junction of the lower section or support base (38) with the central part of the ring or peripheral wall (22) and, of the lower lid or base (30) with the external peripheral wall of the ring or of an amorphous FIG. 22) with the lower part of the container body (10).

It should be understood from the description of the present invention, that many other forms of containers can be manufactured under this concept, for example, the body of the container can be made of any geometric or amorphous figure, including its base that can be circular, triangular, square or an amorphous figure. Said lower cover or base and ring being coupled by thread or by means of a hermetic or sealing assembly process.

1. A container with an inner decorative figure, comprising:
a container body having a top cover, said top cover including an outlet neck projecting from the central portion to engage a cap or an atomizer; and, a geometric or amorphous through-peripheral wall in the lower part of the container body, said geometric or amorphous through-peripheral wall having an external peripheral wall and an internal peripheral wall, said external peripheral wall having a threaded section or a peripheral engagement flange;
a figure or decorative piece including an upper section with the desired figure and a lower section or support base, said lower section or support base having a stop section to delimit the entrance of the figure or decorative piece towards the inside of the container; and,
a lower cap or base that is coupled to the lower part of the container body to retain and maintain fixed the position of the lower section or support base of the decorative figure.

2. The container with an inner decorative figure according to claim 1, wherein the body of the container is in the shape of a prism, pyramid or truncated cone, cylindrical or of any amorphous shape.

3. The container with an inner decorative figure in accordance with claim 1, wherein the through-peripheral wall geometric or amorphous shape includes an external peripheral wall and an internal peripheral wall, said external peripheral wall having a threaded section or peripheral engagement flange.

4. The container with an inner decorative figure according to claim 1, wherein the lower section or support base of the decorative piece comprises: a first external peripheral wall to be assembled in contact with the internal peripheral wall of the through-peripheral wall geometric or amorphous shape; and, a second peripheral or base wall located at the bottom of said external peripheral wall, said second peripheral or base wall being of a diameter greater than said first external peripheral wall.

5. The container with an inner decorative figure according to claim 1, wherein the union of the first external peripheral wall and the second peripheral wall or base plate forming a stepped section, which serves as a stop when the decorative figure is introduced towards the inside of the container.

6. The container with an inner decorative figure according to claim 1, wherein the lower cap or base includes: a lower plate;
an external peripheral wall, which projects vertically upwards and in linear coincidence, in the same plane, with the external wall of the body of the container; a first internal peripheral wall having a threaded or engaging section; and, a second peripheral retaining wall located on the inside of the lower cover or base to retain and maintain fixed the position of the lower section or support base of the decorative figure.

7. A method for manufacturing a container with an inner decorative figure comprising the steps of:
forming a container body with an top cover, said top cover including an outlet neck projecting from the central part to engage a cap or an atomizer; and, a through-ring or peripheral wall in the lower part of the container body, said ring having an external peripheral wall and an internal peripheral wall, said external peripheral wall having a threaded section or peripheral sealing lip;
forming a figure or decorative piece including an upper section with the desired figure and a lower section or support base, said lower section or support base having a stepped or stop section;
introducing the figure or decorative piece into the internal part of the container body through the central part of the through-ring or peripheral wall until the stop section of the lower section or base support coincides with a lower part of the ring or peripheral through wall, to delimit the entrance of the figure or decorative piece towards the internal part of the container; and.
coupling a bottom cap or base to the external peripheral wall of the ring of the lower part of the container body, to retain and maintain fixed the position of the lower section or supporting base of the decorative figure.

8. The method for manufacturing the container with an inner decorative figure in accordance with claim 7, including the step of: hermetically sealing the union of the lower section or support base with the central part of the ring or peripheral wall and, of the bottom cap or base with the external peripheral wall of the ring or of an amorphous figure with the bottom of the container body.
